(19) United States
(12) Patent Application Publication
(10) Pub. No.: US 2010/0040070 A1
(43) Pub. Date: Feb. 18, 2010

(54) NODE DEVICE AND METHOD FOR DECIDING SHORTEST PATH USING SPANNING TREE

(76) Inventors: Chang-Jin Suh, Seoul (KR); Ji-Soo Shin, Seoul (KR); Kyung-Mi Kim, Gyeonggi-Do (KR); Shin-Woong Jung, Seoul (KR)

Correspondence Address: LADAS & PARRY LLP, 224 SOUTH MICHIGAN AVENUE, SUITE 1600, CHICAGO, IL, 60604, US

(21) Appl. No.: 12/369,131

(22) Filed: Feb. 11, 2009

(30) Foreign Application Priority Data
Aug. 14, 2008 (KR) 10-2008-0080001

(51) Int. Cl. H04L 12/56

(52) U.S. Cl. 370/400

(57) ABSTRACT

Provided are a node device and a method for deciding a shortest path using a spanning tree. The node device includes: a node division unit dividing the node device into sub-nodes as many as the number of nodes connected to the node device when the node device operates an edge node that is located at an end of a backbone network and is in charge of reformatting and routing frames; a spanning tree generation unit generating as many spanning trees as the number of sub-nodes, wherein each of the spanning trees comprises a shortest path to reach the other edge nodes constructing the backbone network from each of the sub-nodes; and a first path decision unit deciding a shortest path from a source node to a predetermined destination node, as a path to be used, based on the spanning trees that are generated by the spanning tree generation unit. The shortest path that is obtained based on the plurality of spanning trees is used as a path to be used such that throughput of traffic is 3 times and 1.5 times larger than in existing STP and SPB, respectively, and the transmission delay is smaller than in existing STP and SPB. In addition, packet loss is smaller than in STP and SPB, and the node device and the method for deciding a shortest path using a spanning tree are robust to the unbalanced traffic.

### CROSS-REFERENCE TO RELATED PATENT APPLICATION

This application claims the benefit of Korean Patent Application No. 10-2008-0080001, filed on Aug. 14, 2008, in the Korean Intellectual Property Office, the disclosure of which is incorporated herein in its entirety by reference.

### BACKGROUND OF THE INVENTION

1. Field of the Invention

The present invention relates to a node device and a method for deciding a shortest path using a spanning tree, and more particularly, to a node device and a method for deciding a shortest path using a spanning tree by which all edge nodes are divided into as many sub-nodes as the number of nodes connected to all of the edge nodes so that a shortest path can be found.

2. Description of the Related Art

Ethernet, first developed in the early 1970s, was actually a standard of 10 Mbps Local Area Network (LAN). At the early 1990s, the speed of Ethernet improved up to 100 Mbps, 1 Gbps, and 10 Gbps. Due to the success of Metro Ethernet in 2000s, Ethernet has been pervading to backbone networks.

Layer-2 networks currently use Spanning Tree Protocol (STP), defined in IEEE802.1D, and Multiple Spanning Tree Protocol (MSTP), defined in IEEE802.1s. Recently, standardization of Shortest Path Bridging (SPB), defined in IEEE802.1aq, is in progress. STP constitutes a single spanning tree for routing. MSTP improves STP by allowing multiple spanning trees. In addition, SPB is based on MSTP and constitutes n shortest path spanning trees rooted at each node in n-node backbone networks.

Carrier Ethernet, defined in IEEE802.1ah, integrates distributed layer-2 bridged networks to a Provider Backbone Bridged Network (PBBN). PBBN consists of two types of nodes—Backbone Edge Bridge (BEB) and Backbone Core Bridge (BCB). BEBs are located at the edge of a network and are in charge of routing and reformatting frames. BCBs are located in a core network and forward many frames at a high speed. A BEB connects a plurality of layer-2 bridged networks, and a core network integrates BEBs. A BEB receives frames and forwards them to destination BEBs via PBBN core network.

A procedure of development of major layer-2 STP based routing protocols and criteria for layer-2 routing is as follows. The first and most basic layer-2 routing protocol is STP. Layer-2 routing protocols are built on spanning trees. A spanning tree is configured autonomously without the need of a manager's work in interconnected networks of several Ethernets, and all frames are forwarded along the spanning tree.

When outage of nodes or links occurs in network in which STP operates, the spanning tree is re-configured. STP spends about 30 seconds for re-configuration of the spanning tree. Packet transmission is stopped during transient time. In order to reduce time when packet transmission is stopped, Rapid Spanning Tree Protocol (RSTP) has been introduced. RSTP considerably reduces the re-configuration time to tens of millisecond scale. However, RSTP establishes a same spanning tree as STP. In addition, RSTP uses only a single spanning tree. Thus, due to an unused link that does not belong to the spanning tree, the rate of using a link is considerably reduced. Thus, throughput is small, and a packet loss is large. RSTP and STP are integrated to the name of STP, and the name RSTP is not publicly used any more.

MSTP may be regarded as an extension of RSTP in the sense that multiple RSTPs coexist in a region. MSTP divides a network into considerably independent regions and constructs multiple spanning trees at each of divided regions. MTSP integrates the multiple spanning trees formed in each of the divided regions so that the multiple spanning trees operate in the entire network. MSTP is a very complex to include many important concepts like multi-regions, multi-STPs.

Recently, SPB that operates in a simpler manner than MSTP and increases efficiency of using a network has been proposed. Owing to this advantage, a routing method that is used in Carrier Ethernet is expected to be developed as SPB in future from the current MSTP. SPB generates as many spanning trees as the number of nodes in a region and constructs each of the spanning trees based on each node. SPB shows excellent performance in all aspects like a packet loss rate, average transmission delay, throughput, etc. SPB is the most excellent method of the currently-proposed layer-2 routing methods.

Our major interest is to find out the way to increase throughput. Throughput is defined as the successfully transferred data rate at a given network. Because traffic from edge nodes contributes to most throughput, our explanation focuses on the traffic generated by edge nodes and assumes that there is no traffic from core nodes as well as to core nodes.

Meanwhile, there are a few researches that tried to improve spanning tree based layer-2 routing but showing less throughput. The SmartBridge learns network and forwards traffic through shortest path with reduced delay. SmartBridges should set up a solution for load balancing and for interworking procedure in non-Smart Bridges and Smart Bridges during reconfiguration.

Spanning Tree Alternate Routing (STAR) provides multiple routing paths an original spanning tree and alternative routes. Some traffic uses alternative routes which are shorter than the original spanning tree with reduced transmission delay. STAR needs to define reorganization process and prevention of link overload. ENDIST outperforms these two works and interworking problem is easy because it heavily relies on SPB.

Viking uses multiple spanning trees in conjunction with Virtual LAN (VLAN) to improve the overall throughput performance of the network by multiple redundant links, and improves fault-tolerant features with a pre-established backup path. To make the backup path, Viking needs an additional server.

### SUMMARY OF THE INVENTION

The present invention provides a node device and a method for deciding a shortest path using a spanning tree by which excellent performance in throughput, transmission delay, and a packet loss rate can be shown by using edge node division and simultaneously, re-configuration delay in which use of the node device is inhibited can be significantly reduced.

The present invention also provides a computer readable recording medium having recorded thereon a program for executing a method for deciding a shortest path by which excellent performance in throughput, transmission delay, and a packet loss rate can be shown by using edge node division and simultaneously, a re-configuration delay in which use of the node device is inhibited can be significantly reduced.

According to an aspect of the present invention, there is provided a node device, the node device including: a node division unit dividing the node device into sub-nodes as many as the number of nodes connected to the node device when the node device operates an edge node that is located at an end of a backbone network and is in charge of reformatting and routing frames; a spanning tree generation unit generating as many spanning trees as the number of sub-nodes, wherein each of the spanning trees includes a shortest path to reach the other edge nodes constructing the backbone network from each of the sub-nodes; and a first path decision unit deciding a shortest path from a source node to a destination node, as a path to be used, based on the spanning trees that are generated by the spanning tree generation unit.

According to another aspect of the present invention, there is provided a method for deciding a shortest path using a spanning tree at an edge node that is located at an edge of a backbone network and is in charge of reformatting and routing frames, the method including: dividing the node device into sub-nodes as many as the number of nodes connected to the node device; generating as many spanning trees as the number of sub-nodes, wherein each of the spanning trees includes a shortest path to reach the other edge nodes constructing the backbone network from each of the sub-nodes; and deciding a shortest path from a source node to a predetermined destination node, as a path to be used, based on the spanning trees.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a detailed structure of a node device according to an embodiment of the present invention;

FIG. 2 illustrates a small backbone network according to an embodiment of the present invention to be used in data analysis;

FIGS. 3A and 3B illustrate a temporary spanning tree rooted at a sub-node B1 that exclusively uses link B1-G and a temporary spanning tree rooted at a sub-node B2 that exclusively uses link B2-J, respectively;

FIGS. 4A and 4B illustrate spanning trees that are finally generated by the spanning tree generation unit from the temporary spanning trees illustrated in FIGS. 3A and 3B by using the above-described method, respectively;

FIG. 5 is a flowchart illustrating a method for deciding a shortest path using a spanning tree according to an embodiment of the present invention;

FIG. 6 illustrates an example of a large backbone network to be used in data analysis;

FIG. 7 shows the throughput when the upward traffic rate ‘e’ is 20% in the small backbone network using analytic model;

FIGS. 8A through 8C show spanning trees whose root nodes are denoted as slashes generated by STP, SPB, and ENDIST respectively in the small backbone network;

FIGS. 9A and 9B show maximum throughput for each routing method with symmetrical and non-symmetrical distribution when the upward traffic rate e=0.2 in the large backbone network using analytic model;

FIGS. 10A and 10B show maximum throughput for each routing method with symmetrical and non-symmetrical distribution when the upward traffic rate e=0.5 in the large backbone network using analytic model;

FIG. 11 shows comparison of maximum throughput in the small backbone network and the large backbone network under upward traffic rate e is 0.5 using analytic model;

FIG. 12 shows transmission delay for STP, SPB, and ENDIST routing with symmetrical distribution when the upward traffic rate ‘e’ is 20% in the small backbone network using simulation model;

FIG. 13 shows a packet loss rate for STP, SPB, and ENDIST routing when the upward traffic rate ‘e’ is 20% with symmetrical distribution in the small backbone network using simulation model;

FIGS. 14A and 14B show the throughput with symmetrical and non-symmetrical load distribution, respectively, when the upward traffic rate is 50% in the large backbone network using simulation model;

FIGS. 15A and 15B show the average delay in symmetrical and non-symmetrical load distribution, respectively, when the upward traffic rate is 50% in the large backbone network using simulation model; and

FIGS. 16A and 16B show the packet loss rate in symmetrical and non-symmetrical load distribution, respectively, when the upward traffic rate is 50% in the large backbone network using simulation model.

### DETAILED DESCRIPTION OF THE INVENTION

Hereinafter, the present invention will be described in detail by explaining exemplary embodiments of the invention with reference to the attached drawings.

Backbone networks have the following characteristics. First, networks are very regular. Second, an edge node has multiple links to reach a core network for guaranteeing reliability.

Based on the above-mentioned two characteristics, the present invention proposes a routing algorithm that uses multiple end-to-end paths simultaneously. Layer-2 routing protocol includes a plurality of spanning trees and has a single routing path between two end nodes for a given flow. If single path limitation is alleviated, a better routing path can be used in consideration of a status of network. Routing scheme that is proposed according to the present invention is Edge Node Divided Spanning Tree (ENDIST) that enhances transmission ability of spanning trees.

The present invention operates as follows. First, as many paths that can be used when packets are transmitted from a source edge node to a destination node, as the number of links connected to edge nodes are prepared. When the packets are input to an edge node, a path is selected from multiple paths that can be used in consideration of a situation of network, and the packets are transmitted along the selected path. A path that is not selected during packet transmission is used in preparation for the case where outage occurs in links or nodes and a path cannot be used any more.

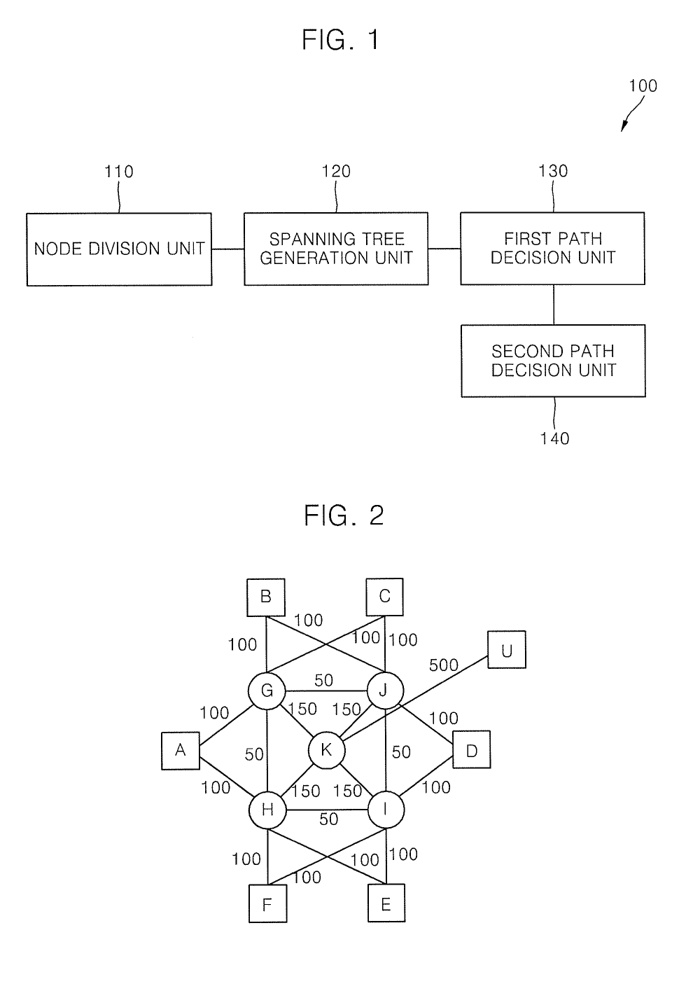

FIG. 1 is a block diagram illustrating a detailed structure of a node device 100 according to an embodiment of the present invention. Referring to FIG. 1, the node device 100 according to the current embodiment includes a node division unit 110, a spanning tree generation unit 120, a first path decision unit 130, and a second path decision unit 140.

When the node device 100 according to the current embodiment operates an edge node that is located at an end of the backbone network and is in charge of reformatting and routing frames, the node division unit 110 divides the node device 100 into sub-nodes as many as the number of nodes connected to the node device 100. In the present invention, an edge node is regarded as union of sub-nodes as many as the number of links or nodes that are connected to the edge node. Each link connection of an edge node is exclusively used as a first link in a routing path to reach all the other edge nodes. In other words, a sub-node and the first link are directly connected, and no-switching is allowed between them.

The node division unit 110 divides Media Access Control (MAC) addresses into two address regions and allocates them to each of the sub-nodes. Lower two to three bits are used as a sub-node serial number, and the other, identical upper bits as the number of nodes are assigned to all of the sub-nodes. The division method, the addresses of the nodes, and a bit number that indicates a sub-address region are applied to all of nodes of a network to be applied. In this way, new address system and addresses are needed so that the node division unit 110 allocates addresses to the sub-nodes. IEEE802.1ah adopts MAC-in-MAC addressing that allows an additional MAC address except for its own MAC address used at the lower networks. Thus, when the MAC addresses to be additionally allocated to each node are set, information about node division may be included.

When a MAC-in-MAC operation is performed at an edge node composed by two sub-nodes in a network in which lower two bits are used as a sub-node serial number, in packets input to the backbone network, a MAC address that is used in the backbone network is written as a new MAC address in a region from which the last two bits are excluded, and the sub-node serial number is written in the other two bits according to a path in which the packets are to be transmitted. In addition, a destination node MAC address that is used in the backbone network is written as a destination MAC address in a region from which the last two bits are excluded, and the sub-node serial number is written in the other two bits according to a path in which the packets are to be transmitted.

FIG. 2 illustrates an example of a backbone network according to an embodiment of the present invention. Referring to FIG. 2, circles indicate core nodes, and squares denote edge nodes. An edge node U is a special gateway bridge that provides an outlet to as well as an inlet from an upper level network. All the other edge nodes are connected from lower level metro networks. Here, nₑ is the number of edge nodes in a backbone network and is 7. In FIG. 2, the gateway bridge U has a connecting link, and each of the edge nodes has two connecting links.

The spanning tree generation unit 120 generates as many spanning trees as the number of sub-nodes, wherein each of the spanning trees includes a shortest path to reach the other edge nodes constructing the backbone network from each of the sub-nodes. To this end, the spanning tree generation unit 120 must know the number of the sub-nodes of all the other edge nodes of the backbone network. For the backbone network illustrated in FIG. 2, existing Shortest Path Bridging (SPB) generates spanning trees in node unit and thus generates nₑ shortest spanning trees. The spanning tree generation unit 120 generates spanning trees by using SPB in sub-node unit. Thus, (2nₑ−1) shortest spanning trees rooted at each sub-node are generated. To generate spanning trees, the spanning tree generation unit 120 first generates temporary spanning trees including a path to reach sub-nodes of the other edge nodes and the other intermediate nodes.

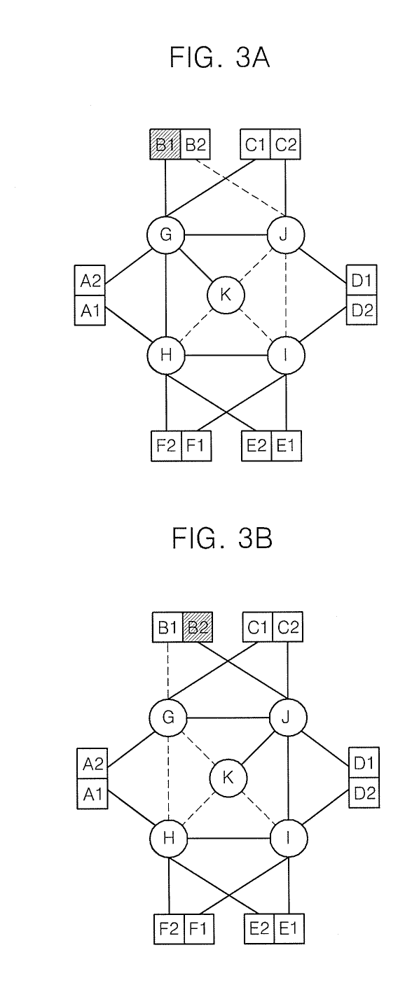

FIGS. 3A and 3B illustrate a temporary spanning tree rooted at a sub-node B1 that exclusively uses link B1-G and a temporary spanning tree rooted at a sub-node B2 that exclusively uses link B2-J, respectively. FIGS. 3A and 3B omit the node U for simplicity. Referring to FIGS. 3A and 3B, each edge node excluding U has two connecting links and two sub-nodes. Spanning trees provide the shortest path from the root to all edge nodes. For example, in the temporary spanning tree illustrated in FIG. 3A, the spanning tree generation unit 120 generates a temporary spanning tree from a sub-node B1 to sub-nodes of all of the other edge nodes by using spanning tree protocol (STP), excluding a path from the sub-node B1 to the sub-node B2.

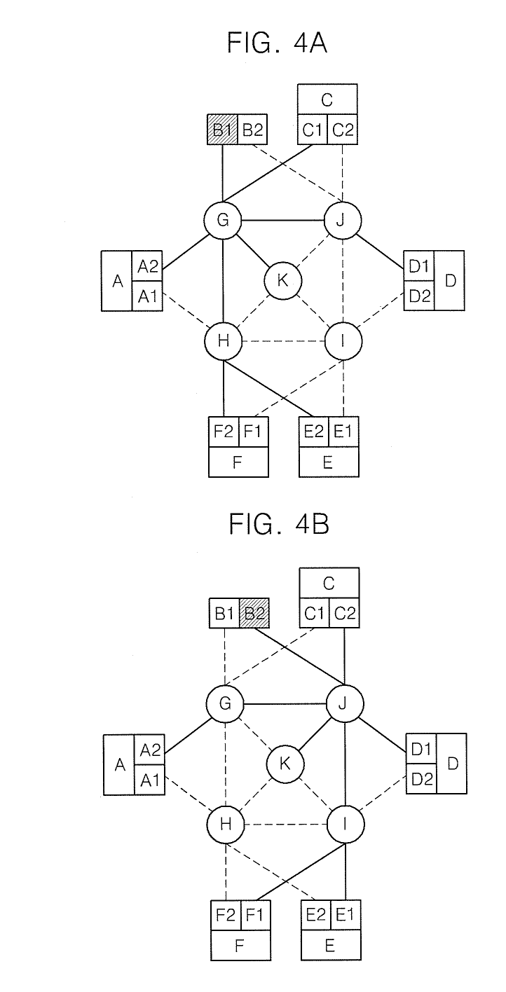

Next, the spanning tree generation unit 120 prunes links including a long path from the temporary spanning tree generated in each of the sub-nodes to the other edge nodes and they will be saved for backup paths. Links connected to the sub-nodes must be used in a path between two of the sub-nodes. Thus the shortest path between the two sub-nodes may not be provided. Thus a longer path than the shortest path should be pruned. In this procedure, the spanning tree generation unit 120 prunes a portion of the path without changing the path generated by the spanning tree generation unit 120. In the temporary spanning tree illustrated in FIG. 3A, two paths from the sub-node B1 to the other edge node A include path B1->G->A2 and path B1->G->H->A1. Thus, the spanning tree generation unit 120 prunes links in a path from an intermediate node G having a long path to a sub-node A1 between the two paths from the sub-node B1 to the other edge node A. FIGS. 4A and 4B illustrate spanning trees that are finally generated by the spanning tree generation unit 120 from the temporary spanning trees illustrated in FIGS. 3A and 3B by using the above-described method, respectively.

The first path decision unit 130 decides a shortest path from a source node to a predetermined destination node, as a path to be used, based on the spanning trees that are generated by the spanning tree generation unit 120. For example, when the source node is B and a destination node is A, the shortest path on the spanning tree of FIG. 4A is path B1->G->A1, whereas the shortest path on the spanning tree of FIG. 4B is path B2->J->G->A2. Thus, the first path decision unit 130 decides a path of B1->G->A, which is the shortest path on the spanning tree of FIG. 4A, as a path to be used. In addition, when the source node is B and the destination node is F, the shortest path on the spanning tree of FIG. 4A is B1->G->H->F2, and the shortest path on the spanning tree of FIG. 4B is B2->J->I->F1. Thus, the two shortest paths have the same lengths. Thus, the first path decision unit 130 decides the two paths are to be used.

The second path decision unit 140 decides a final path among a plurality of paths in consideration of an output queue length or end-to-end transmission delay when there are a plurality of paths decided by the first path decision unit 130. When only an output queue is used as criteria for deciding a final path, even though the state of the other nodes is not known, the final path can be decided, and the second path decision unit 140 may be simply implemented. However, when end-to-end transmission delay is known according to paths by aid of a control message, traffic can be more delicately distributed and routing can be performed based on end-to-end transmission delay. When an output queue is used, the second path decision unit 140 compares the length of the output queue when new flow occurs and allocates flow as an output having a small length. The second path decision unit 140 may be integrated to the first path decision unit 130 and may be implemented in a shape of a path decision unit.

Layer-2 routing must be based on a First In First Out (FIFO) rule in which a first-transmitted packet first arrives in end-to-end transmission. In existing layer-2 routing, only a single path is used when a source and a destination are defined. Thus, the FIFO rule is always kept. However, in the present invention using a plurality of paths, in order to select a path while keeping the FIFO rule, a path is selected in flow unit. In the present invention, when a new flow appears, a source edge node selects a spanning tree that is appropriate to a corresponding flow and keeps a path selected on the corresponding spanning tree until the flow expires. Flow means a series of packets in which a source and a destination are identical and transmission requirements or characteristics are identical. As the backbone network serves humongous amount of traffic, flows constantly appear and disappear. When a new flow appears, an edge node selects a spanning tree for every destination node.

The above-mentioned operation of the second path decision unit 140 will be described in more detail with reference to FIGS. 4A and 4B. The second path decision unit 140 must decide a path that is to be finally used, among a path of B1->G->H->F2 of FIG. 4A and a path of B2->J->I->F1 of FIG. 4B having the same length. In this case, the second path decision unit 140 compares the length of a packet in a standby state for use of the link B1-G with the length of a packet in a standby state for use of the link B2-J, decides a path having a small length as a final path, and uses the same path until the flow expires.

In each of a plurality of spanning trees that are generated by the spanning tree generation unit 120, a shortest path that is not decided as a path to be used, by the first path decision unit 130 or the second path decision unit 140 among shortest paths that reach a destination node, is not usually used. However, when outage occurs in links or nodes and a path cannot be used any more, the shortest path is used as a backup path. In a regular backbone network, there may be a plurality of shortest paths between edge nodes. Thus, the first path decision unit 130 may keep the plurality of shortest paths according to a destination.

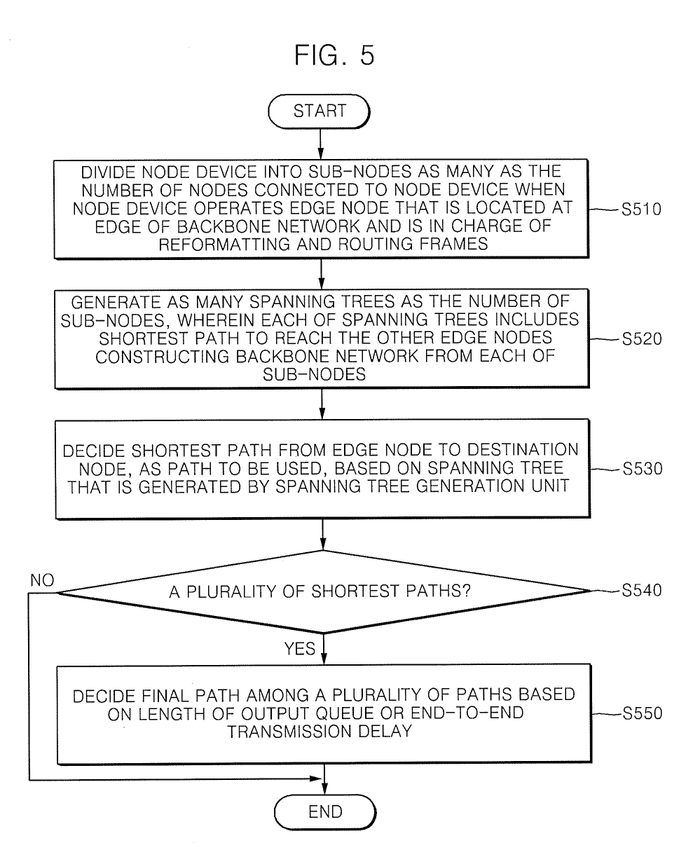

FIG. 5 is a flowchart illustrating a method for deciding a shortest path using a spanning tree according to an embodiment of the present invention.

Referring to FIG. 5, when the node device 100 of FIG. 1 operates an edge node that is located at an end of the backbone network and is in charge of reformatting and routing frames, the node division unit 110 divides the node device 100 into sub-nodes as many as the number of nodes connected to the node device 100 (S510). In this case, the node division unit 110 divides MAC addresses into two address regions and allocates them to each of the sub-nodes by using lower two to three bits as a sub-node serial number in consideration of a given backbone network. Next, the spanning tree generation unit 120 generates as many spanning trees as the number of sub-nodes, wherein each of the spanning trees includes a shortest path to reach the other edge nodes constructing the backbone network from each of the sub-nodes (S520). In this case, the spanning tree generation unit 120 generates a temporary spanning tree including a path from sub-nodes of the other edge nodes to the other intermediate nodes and prunes links including a long path among links connected to sub-nodes of another edge node of the temporary spanning tree, thereby generating the spanning trees that include a shortest path from a sub-node to all of the other nodes. Next, the first path decision unit 130 decides a shortest path from an edge node to a predetermined destination node, as a path to be used, based on the spanning tree that is generated by the spanning tree generation unit 120 (S530). If a plurality of shortest paths are used as the path to be used, by using the first path decision unit 130 (S540), the second path decision unit 140 decides a final path among a plurality of paths in consideration of the length of an output queue or end-to-end transmission delay (S550).

Hereinafter, performance of Edge Node Divided Spanning Tree (ENDIST) is verified by performing comparison simulation of SPB, STP, and ENDIST. In this case, ENDIST is evaluated by using an NS-2 simulator and is compared with STP routing based on a single spanning tree, SPB routing based on MSTP, and perfect routing that uses all links.

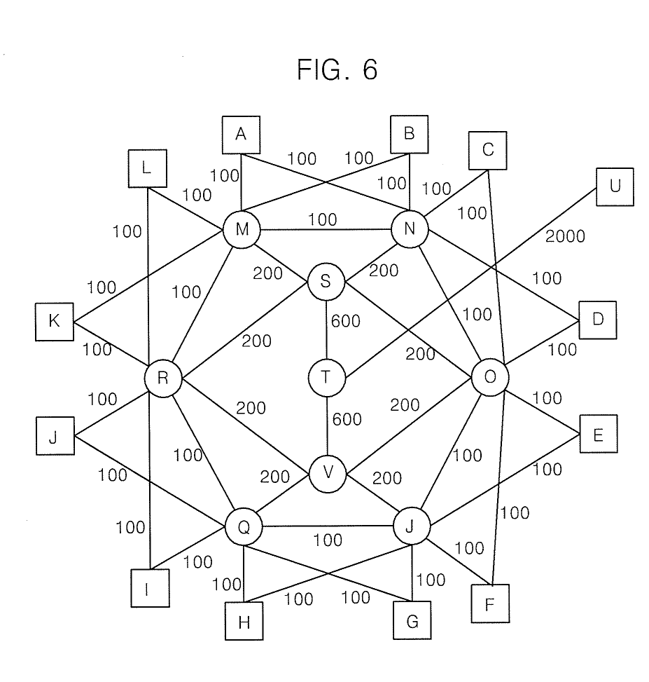

FIG. 6 illustrates an incidence of a large backbone network. Simulation and analytic model will be built on the small backbone network of FIG. 2 and the large backbone network of FIG. 6. It is assumed that all links during simulation are full-duplex in 10 Gbps. A link capacity is written on each link in Gbps. For example, a link of capacity 50 has five channels of 10 Gbps, and a link cost is regarded as 10 Gbps. Even though ENDIST chooses a spanning tree as flow based, we assume that the shortest path on a plurality of spanning trees is selected based on the number of packets (not based on a flow) for simplicity.

In this simulation, we assume load distribution as follows: The entire edge nodes except the node U forward the rate ‘e’, called upward traffic rate, to the upper level of network. The other portion (1−e) of traffic is distributed to the rest of edge nodes fairly with an exception of popular nodes. A popular node is a privileged node that receives traffic twice much as a normal node does. If there is no popular node, we call the distribution is symmetric. Otherwise, it is non-symmetrical. The node U generates downward traffic of the same amount as upward traffic.

In a special simulation of non-symmetrical distribution, we assume there are a quarter of popular nodes among edge nodes except the node U. The node U forwards to the other edge nodes fairly, and in the popular node, traffic twice much as a normal node does is transmitted. In the present invention, by default, we assume symmetrical distribution. In the simulation, when an output queue is too much during transmission, input packets are lost.

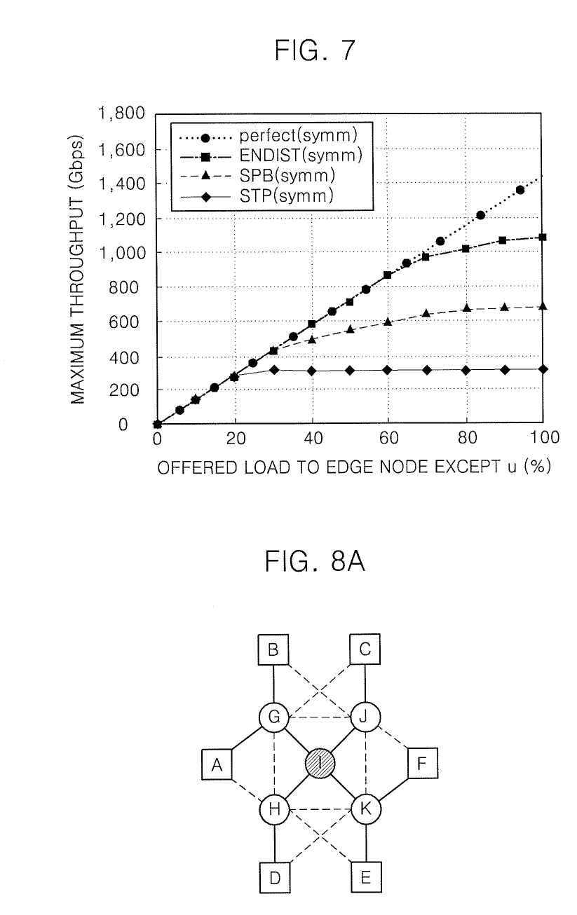

FIG. 7 shows the throughput when the upward traffic rate ‘e’ is 20% in the small backbone network.

Referring to FIG. 7, vertical axis indicates the throughput in the backbone network. The perfect routing shows that it performs perfectly at all load without a packet loss. FIG. 7 indicates ENDIST is the most outperform except perfect routing and STP is worst. The difference comes from the number of spanning trees. In other words, STP uses a single spanning tree, on the other hand, SPB uses spanning trees as many as edge nodes. In ENDIST, we use spanning trees as many as sub-nodes. Data for perfect routing are obtained from the layer-2 routing analytic model by linear programming. According to the present invention, the theoretical upper bound of throughput is calculated by using a maximum flow linear programming problem. Hereinafter, the layer-2 routing analytic model by performing linear programming will be described.

The linear programming analytic model solves the multi-input and multi-output maximum flow problem in backbone networks using the following method. Firstly, the analytic model suggests appropriate link capacity if network and traffic pattern are given. Secondly, the analytic model shows and compares the performance of layer-2 routing methods including perfect routing and our proposed routing called ENDIST.

ENDIST basically uses SPB. ENDIST generates spanning trees as many as the number of all sub-nodes, while SPB generates them as many as the number of nodes. In a backbone network, edge nodes are always connected to the core node with two or more links for redundancy. By using the characteristic, each edge node in ENDIST has sub-nodes as many as connecting links. Use of multiple routing paths contributes to considerable throughput enhancement. The adoption of sub-node is easily implemented by writing source and destination sub-node addresses in the MAC-address field.

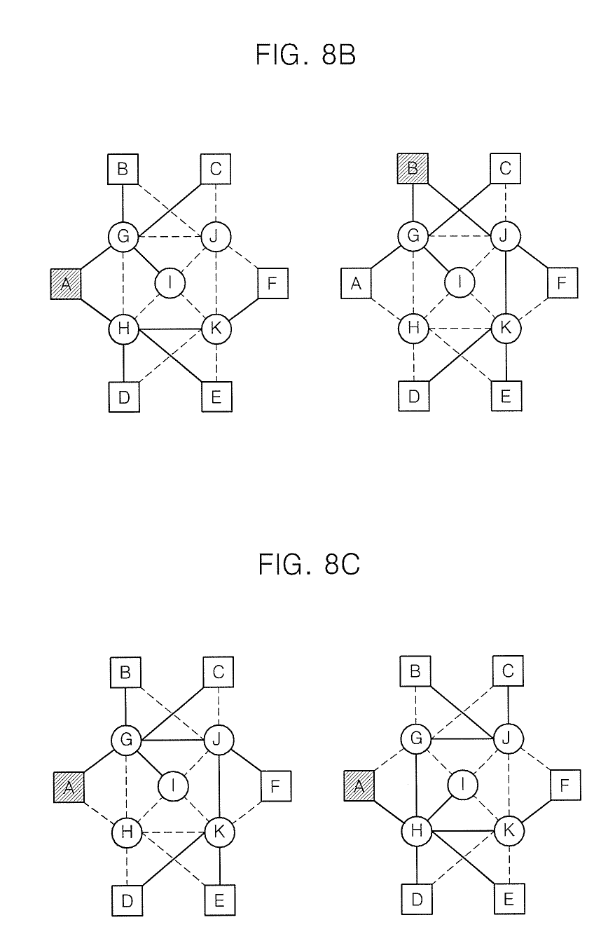

FIGS. 8A through 8C show spanning trees generated by STP, SPB, and ENDIST in the backbone network of FIG. 2, respectively. FIG. 8C shows two best paths describing the routing path from node A in the backbone network in FIG. 2 represented as bold lines. When we fix the destination node F, they are A->G->J->F in the left spanning tree and A->H->K->F in the right one in FIG. 8C. In this regard, if a popular node exists in the lower parts of the backbone network, an edge node A prefers the path A->G->J->F to the path A->H->K->F. While keeping spanning trees as many as sub-nodes, sub-node selection is done in flow-basis. When a first packet in the flow arrives, the sub-node is decided. The later packets use the same path that the first packet uses.

In the present invention, STP, SPB, ENDIST, and perfect routing are considered. The number on each link in FIG. 2 indicates the link capacity. We assume that all links are full duplex and uses 10 Gbps transmission medium only. For example, a link of capacity 50 has five 10 Gbps channels. Referring to FIGS. 8A through 8C, solid lines indicate active links that constitute the spanning tree, and dotted lines mean inactive ones. In FIGS. 8A through 8C, the root node which is a source node, is indicated by a hatched line.

STP establishes a single spanning tree as shown in FIG. 8A. SPB generates spanning trees as many as edge nodes. FIG. 8B shows two spanning trees rooted at the nodes A and B among seven spanning trees generated by SPB. Each edge has four sub-nodes, and all other six edge nodes have two sub-nodes respectively. There are totally sixteen spanning trees in ENDIST. FIG. 8C shows two routing paths rooted at node A generated by ENDIST. Lastly, we define the ‘perfect’ routing method that uses the entire links in network. The output result of perfect routing is the ideal upper bound in a network, and this result is compared with the result of the layer-2 routing methods.

From now we are going to show two types of analysis tools and are going to generate many results from the tools that show the performance of many layer-2 routing methods. The first tool is the analytic model using linear programming. It solves the multi-input and multi-output maximum flow problem in backbone networks and calculates maximum throughput the each routing method can reach. Thus, if we have implemented version of ENDIST, we can check how close the reality is to the target. If implemented routing method performs significantly lower than the limit, we recommend some modifications or addition about the routing method to improve performance. Besides, the analytic model suggests appropriate values of link capacity if network and traffic pattern are given. If we construct network based on the values, we can balance the traffic and network construction cost may be reduced.

The analytic model assumes the itemized operation policies.

P1 (forwarding action in an edge node): The offered load g(a,z) in Table 1 at an edge node a is forwarded to a pre-selected link to reach the destination node z.

P2 (forwarding action in a core node): A core node merges all inflows and forwards them to an outlet link to reach the destination node.

P3 (no transit service via edge nodes): No edge node is allowed to use as a transit node.

P4 (perfect scheduling): Core nodes do not lose a frame due to look-ahead screening at the edge nodes

P5 (strong fair delivery): A source edge node delivers the traffic with the same rate as the traffic given from external networks.

The second tool is a simulation model. It uses ns-2 simulation package. It assumes the followings.

R1 (forwarding action in an edge node): The offered load g(a,z) in Table 1 at an edge node a is forwarded to a pre-selected link to reach the destination node z.

R2 (forwarding action in a core node): A core node merges all inflows and forwards them to an outlet link to reach the destination node.

R3 (no transit service via edge nodes): No edge node is allowed to use as a transit node.

R4 (greedy transmission): A node tries to send as much as possible until the output link becomes full.

R5 (fair discarding policy): If loss is inevitable at a node, the node deletes frames in a fair way such that all inflows or offered load to the node has same loss rate.

R6 (additional requirement in ENDIST): In ENDIST, an edge node has to decide the usage rate for each of multiple routing paths.

R1, R2 and R3 are identical to P1, P2 and P3 respectively, which are the assumption of the analytic model. The analytic model produces the maximum throughput due to P4 but it also keeps the very strong constraint P5. Thus, two tools produce very similar graphs.

We explain the analytic model first. The analytic model uses linear programming. Linear programming is a convenient tool for optimizing problem. Many networking problems especially Multi Protocol Label Switching (MPLS) traffic engineering problems are solved by linear programming. Hereinafter, we introduce a few methods of solving the linear programming optimization problem in Ethernet and L2 networks. The linear programming model generates only a flow that provides maximum throughput while observing an operating rule of each routing method. In addition, a routing path in which the least link as possible is used is automatically selected so as to achieve maximum throughput.

In current linear programming, in order to prevent an expedient for increasing throughput by using an expedient in which much flow is transmitted to a close destination and less flow is transmitted to a distant destination, we assume that traffic having the same rate is transmitted to all non-popular nodes, traffic twice much as a non-popular node does is transmitted to popular nodes and successful traffic is first calculated to all source nodes and then traffic is transmitted. According to the assumption, transmission is fairly performed to all destination nodes, and there are no packets that are lost during transmission.

In the present invention, we define the multi-input and multi-output maximum flow problem that will be solved by linear programming in consideration of four routing methods of STP, SPB, ENDIST, and perfect routing. We first explain variables for describing backbone networks and defining routing paths. Throughout the notation, we use variables a and z to denote source node and destination node respectively. If no special comment, a and z are different edge nodes. |A| is the cardinality of the set A.

$${\sum }_{\{ z \vert z ∈ {f}_{z} \}}^{ } g ( a , z )$$

means that summation is done for any value z that belongs to f_{z}.
N_{C}: a set of edge nodes (|N_{C}|=n_{c}),
N_{E}: a set of core nodes (|N_{E}|=nₑ),
N: a set of entire nodes (N=N_{E}∪N_{C}),
u: the only gateway node to an upper level network (uεN_{E})
N_{B}: a set of popular edge nodes that attract traffic than non-popular edge nodes (|N_{P}|=nₚ, N_{B}⊂(N_{E}−u)),
L: a set of entire links,
l(i, j): a directed link from i to j (l(i, j)εL, i,jεN),
c(i, j): link capacity of l(i, j)
B(i, z): a routing variable that lists a set of links that allow to deliver the flow from i to z (iεN, zεN_{E}) according to routing scheme considered

We list up linear programming variables.
g(a, z): the traffic given to an edge node a which will be delivered to z (a, zεN_{E}, a≠z),
K(a): total input flow offered to an edge node a, so

$$K ( a ) = {\sum }_{\{ z \vert z ∈ {N}_{E} - a \}}^{ } g ( a , z )$$

$$a , z ∈ {N}_{E} .$$

d(a,z): successfully delivered traffic from source a to destination z
P(i, j, z): sum of flow to z on the link l(i, j) (zεN_{E}, i,jεN),

We are going to define the traffic load offered from external networks. There are three types of edge nodes in backbone networks. They are a gateway node, popular and non-popular nodes. We assume there is a single gateway node, representing with u which connects the backbone network to an upper level network. Except u, the non-gateway edge nodes are classified as popular and non-popular.

We suppose that both the popular and non-popular edge nodes are given the same input traffic, so we have

K(i)=K(j)i,jε(N_{E}−u) (1)

All non-gateway edge nodes send traffic to the gateway node u with same upward traffic ratio e,

g(a,u)=e·K(a)aε(N_{E}−u) (2)

The other (1−e) portion of traffic offered at a non-gateway source node is evenly distributed to other non-gateway edge nodes. But popular edge nodes attract double traffic than a non-popular edge node does. We assume the gateway edge node u generates traffic as much as it receives from non-gateway nodes. Thus,

$$K ( u ) = {\sum }_{\{ a \vert a ∈ {N}_{E} - u \}}^{ } g ( a , u ) . \qquad ( 3 )$$

Similarly, the gateway edge node evenly distributes traffic to all non-gateway edge nodes, but delivers double traffic to a popular edge node. So we get

$$g ( a , u ) = \{ \begin{matrix}\frac{K ( u )}{{n}_{e} + {n}_{p} - 1} , & if z ∈ ( {N}_{E} - {N}_{P} - u ) \\ \frac{2 \cdot K ( u )}{{n}_{e} + {n}_{p} - 1} , & if z ∈ {N}_{P} .\end{matrix} \qquad ( 4 )$$

Using Equation (1) through (4), we can calculate g(a,z) for all a and z and the result are stored in Table 1. Table 1 is divided into three types of destination nodes in a row and three types of source edge nodes in a column. The defined traffic Table 1 will be commonly used to previous and proposed models.

TABLE 1

| | destination z | | |
|---|---|---|---|
| source a | u | Nₚ | N_{E} − N_{P} − u |
| u | • | $\frac{2 \cdot K ( a )}{{n}_{e} + {n}_{p} - 1}$ | $\frac{K ( a )}{{n}_{e} + {n}_{p} - 1}$ |
| N_{P} | e · K(a) | $\frac{2 \cdot ( 1 - e ) \cdot K ( a )}{{n}_{e} + {n}_{p} - 3}$ | $\frac{( 1 - e ) \cdot K ( a )}{{n}_{e} + {n}_{p} - 3}$ |
| N_{E} − N_{P} − u | e · K(a) | $\frac{2 \cdot ( 1 - e ) \cdot K ( a )}{{n}_{e} + {n}_{p} - 2}$ | $\frac{( 1 - e ) \cdot K ( a )}{{n}_{e} + {n}_{p} - 2}$ |

Abiding by P1 to P5, we can build the analytic model as below. The linear program maximizes the objective function in Equation (10) satisfying linear constraints described in Equation (5) through (9). In the following equations, i indicates a core node, and j and k denote nodes.

$$\begin{matrix}d ( a , z ) = e \cdot {\sum }_{\{ j \vert l ( a , j ) ∈ B ( a , z ) \}}^{ } p ( a , j ; z ) , & ( 5 ) \\ d ( a , z ) \leq g ( a , z ) , & ( 6 ) \\ d ( a , u ) = e \cdot {\sum }_{\{ z \vert z ∈ {N}_{E} \}}^{ } d ( a , z ) , & ( 7 ) \\ {\sum }_{\{ j \vert l ( j , i ) ∈ B ( a , z ) \}}^{ } p ( j , i ; z ) = {\sum }_{\{ k \vert l ( i , k ) ∈ B ( a , z ) \}}^{ } p ( i , k ; z ) , & ( 8 ) \\ {\sum }_{\{ z \vert z ∈ {N}_{E} \}}^{ } p ( i , j ; z ) \leq c ( i , j ) , & ( 9 ) \\ Maximize {\sum }_{\{ z \vert z ∈ {N}_{E} \}}^{ } {\sum }_{\{ a \vert a ∈ {N}_{E} - z \}}^{ } d ( a , z ) . & ( 10 )\end{matrix}$$

From P3 and P4, all traffic leaving the source node a can safely arrive at the destination z. Equation (5) utilizes this property. Equation (6) means the traffic under delivery cannot exceed the offered traffic. Equation (7) is required to keep the upward traffic ratio e. Due to P4, all inflow to a core node i is same as all outflows from i. Equation (8) implements this. Equation (9) means total traffic on a link does not exceed the link capacity.

In the small backbone network of FIG. 2 and the large backbone network of FIG. 6, all links specify link capacities. Hereinafter, how to declare them using FIGS. 2 and 6 will be described. The same capacity is assigned to the same level of links in a backbone network. Link level is defined as follows. All nodes in a backbone network are divided into several levels. So, in FIG. 2, all nodes in the backbone network are divided into four levels such as U,K, (G,H,I,J), and (A,B,C,D,E,F). These levels are named as T1, T2, T3, and T4. A network in FIG. 2 is composed of four types of links such as T1-T2, T2-T3, T3-T3, and T3-T4. That is, {I(U,K)}, {I(K,G), I(K,H), I(K,I), I(K,J)}, {I(G,H), I(H,I), I(I,J), I(J,G)}, {I(A,H), I(A,G), I(B,G), I(B,J), . . . , I(D,I), I(D,J)}.

First, we assign 10 Gbps to T3-T4 link types and decide link capacities of the reminder. We assume that perfect routing is applied to a network and entire edge nodes forward 100% load without loss. And find out minimum capacities of links. To solve this problem, abundant capacities are assigned initially, such as 100 Gbps, to all links. Next, we will repeat to solve a maximum flow problem in concurrence keeping reducing the assigned capacities. This method will determine link capacities differently about upward traffic ratio ‘e’. Concerning minimum capacities obtained in several values of e, we find out link capacities expressed in FIG. 2.

We consider symmetrical and non-symmetrical condition. Symmetrical condition means there is no superior edge node (nₚ=0) in the network and non-symmetrical one means the existence of superior edge nodes (nₚ>0). Since a network in FIG. 2 is small and simple, a performance difference of each routing method cannot be distinguished. So, we will study additional experiment in a large and extended backbone network. We make use of a network expressed in FIG. 6 in order to evaluate the performance of each routing method.

We collect the performance of each layer-2 routing method from the analytic model using the linear program package ILOG CPLEX 9.0. We evaluate the performance of each routing method by two conditions. First, the case 1 assumes that there is no superior edge node (nₛ=0), and the case 2 means the existence of superior edge nodes (nₚ>0). We compare proposed ENDIST routing method with others such as perfect routing, STP routing, and SPB routing. And these routing methods are concisely expressed in perfect, STP, SPB, ENDIST. First of all, we evaluate performance in a large backbone network since the analytic data from small and large backbone networks have a similar pattern. Lastly, we mention the comparison of maximum throughput in the small or large backbone network.

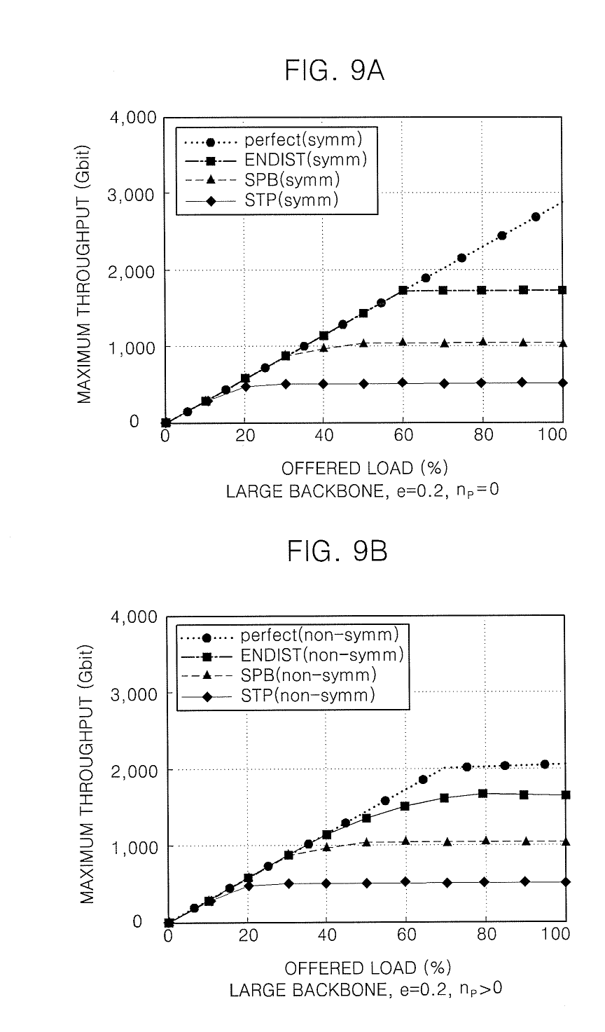

FIGS. 9A and 9B show maximum throughput for each routing method when e=0.2 in the large backbone network.

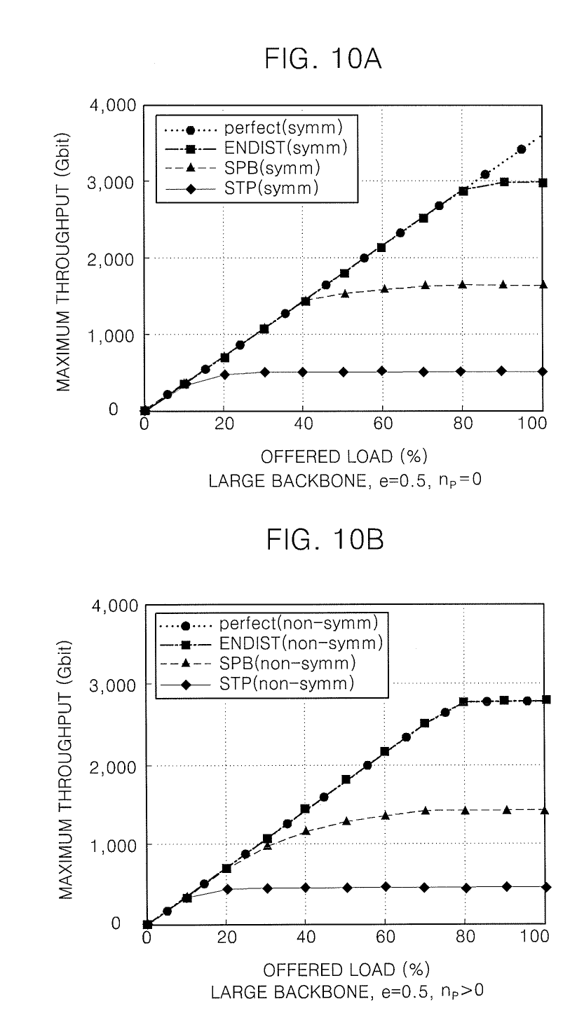

FIGS. 10A and 10B show maximum throughput for each routing method when e=0.5 in the large backbone network.

Referring to FIGS. 9A through 10B, the x-axis is the relative load factor that is loaded to network. For example, 100% means 20 Gbps. Since the bandwidth of each link connected to an edge node is 10 Gbps, 100% of the x-axis means the full of two links that are connected to an edge node. The y-axis means the maximum throughput backbone network can process. As e increases, on the whole, the throughput of each routing method increases too. Especially, the increment of ENDIST is higher than other routing methods and is similar to the performance of perfect that is the ideal upper bound in the target network.

FIGS. 9A and 10A show the performance of each routing method under the condition that the upward traffic rate e is 0.2, 0.5, respectively and the forwarding rule is (nₚ=0). In the case of perfect, the output is expressed in a straight line crossing the origin point, because the entire traffic load is no loss under all the traffic load conditions. All the cases except the perfect routing have the curved lines that are expressed in the straight lines crossing the origin point under the light traffic load. FIGS. 9B and 10B show the performance of each routing method in (nₚ>0) condition. In this case, the throughput of routing methods is decreased on all occasions than (nₚ=0) condition in FIGS. 9A and 10A. As the decrement of ENDIST is lower, the performance gap with perfect grows smaller. Especially in the case of FIG. 10B that upward traffic rate e is 0.5 and if (nₚ>0), forwarding in FIG. 10B shows that ENDIST has the same performance as perfect routing.

In Table 2, we compare the performance of layer-2 routing technology when output of perfect is the standard.

TABLE 2

| | e = 0.2 | | | |
|---|---|---|---|---|
| | (nₚ = 0) | e = 0.2 (nₚ > 0) | e = 0.5 (nₚ = 0) | e = 0.5 (nₚ > 0) |
| ENDIST | 0.67 | 0.82 | 0.93 | 1.00 |
| SPB | 0.41 | 0.50 | 0.51 | 0.56 |
| STP | 0.19 | 0.25 | 0.16 | 0.19 |

Referring to Table 2, four columns represent the output of the above graph in FIGS. 9A through 10B, respectively. If the output of certain routing method is close to 1, the performance of perfect is obtained. It is ascertained that ENDIST is much superior to STP and SPB, and it shows almost perfect performance. Especially under highly upward traffic rate e and in non-symmetrical transmission (nₚ>0), ENDIST shows more performance that is close to perfect.

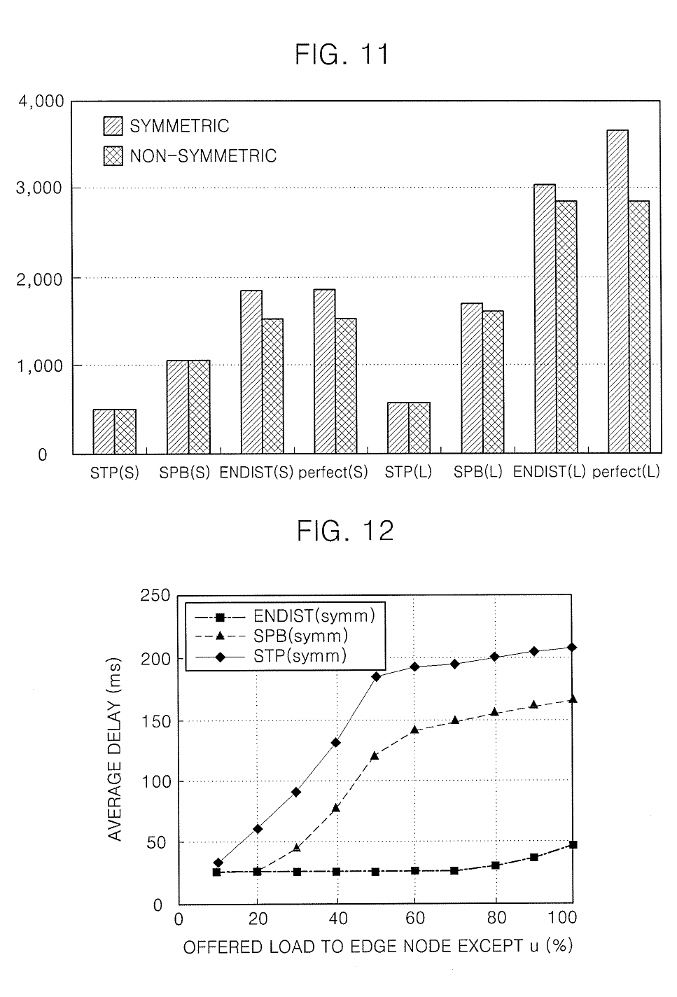

FIG. 11 shows comparison of maximum throughput in the small backbone network and the large backbone network under upward traffic rate e is 0.5.

Referring to FIG. 11, four bar graphs on the left are small backbone network (S), and four bar graphs on the right are large backbone network (L). The x-axis is each routing method, and the output of (nₚ=0) and (nₚ>0) is shown altogether. The y-axis means the maximum output backbone network can process. Generally, the throughput of the small backbone network is lower than that of the large backbone network, but in the small backbone network, the performance of ENDIST equals to that of perfect routing. That is, ENDIST has more ideal performance especially in small sized network. ENDIST is superior routing technology than existing layer-2 routing technology in the aspect of throughput. Especially, the throughput of ENDIST can reach that of perfect routing when it is assumed that upward traffic rate is 0.5 and (nₚ>0) condition. In the actual backbone network, most traffic is likely to concentrate on specified nodes. And much traffic is being forwarded to external backbone network. Thus, ENDIST is suitable routing method in backbone network.

It is proved by the analytic model that ENDIST outperforms performance than the existing layer-2 standard protocols such as STP, MSTP for any offered load and performs perfectly under medium and light traffic load in the given network, thus enough to say that ENDIST is as good as layer 3 routing from the point of throughput.

We use simulation model as a second analysis tool. The simulation model uses ns-2 simulation packages. The simulation model includes the queueing model and can calculate transmission delay.

FIG. 12 shows transmission delay for STP, SPB, and ENDIST routing when the upward traffic rate ‘e’ is 20% in the small backbone network. Referring to FIG. 12, the graph shows ENDIST drastically reduces the transmission delay. The delay of ENDIST under full load is not more than twice the delay at no load. This means the delay in ENDIST even under heavy load is negligible. The delay in STP and SPB increases sharply at middle load and becomes saturated as load increases, because they have limited buffer size. If we simulate again with larger buffer, the delay gap increases from delay of ENDIST.

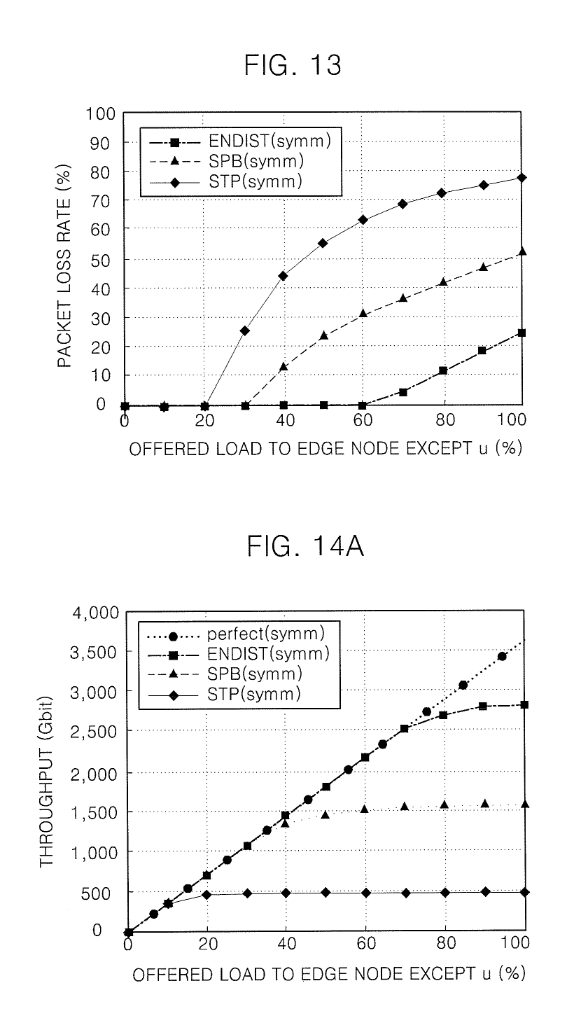

FIG. 13 shows a packet loss rate for STP, SPB, and ENDIST routing when the upward traffic rate ‘e’ is 20% in the small backbone network. Referring to FIG. 13, packet loss is the opposite side of throughput. If load increases constantly, the routing curve digresses from the perfect routing curve in FIG. 7 and packet loss begins occurring at the same load.

Table 3 compares throughputs of ENDIST, SPB, and STP with perfect routing fixed as 1.00, when the traffic ratio ‘e’ transmitted to the upper level network is 20% and 50% and we use symmetrical and non-symmetrical load distribution in the small network.

TABLE 3

| | 20% | 20% | 50% | 50% |
|---|---|---|---|---|
| | (symm) | (non-symm) | (symm) | (non-symm) |
| perfect | 1.00 | 1.00 | 1.00 | 1.00 |
| ENDIST | 0.75 | 0.99 | 1.00 | 1.00 |
| SPB | 0.48 | 0.49 | 0.49 | 0.51 |
| STP | 0.22 | 0.23 | 0.24 | 0.26 |

Referring to Table 3, the throughput of ENDIST is 1.5 to 2 times larger than that of SPB and 3.4 to 4 times larger than that of STP.

Next, the results of simulation that uses two load distribution when the traffic rate ‘e’ transmitted to the upper level network is 50% in the large backbone network are compared.

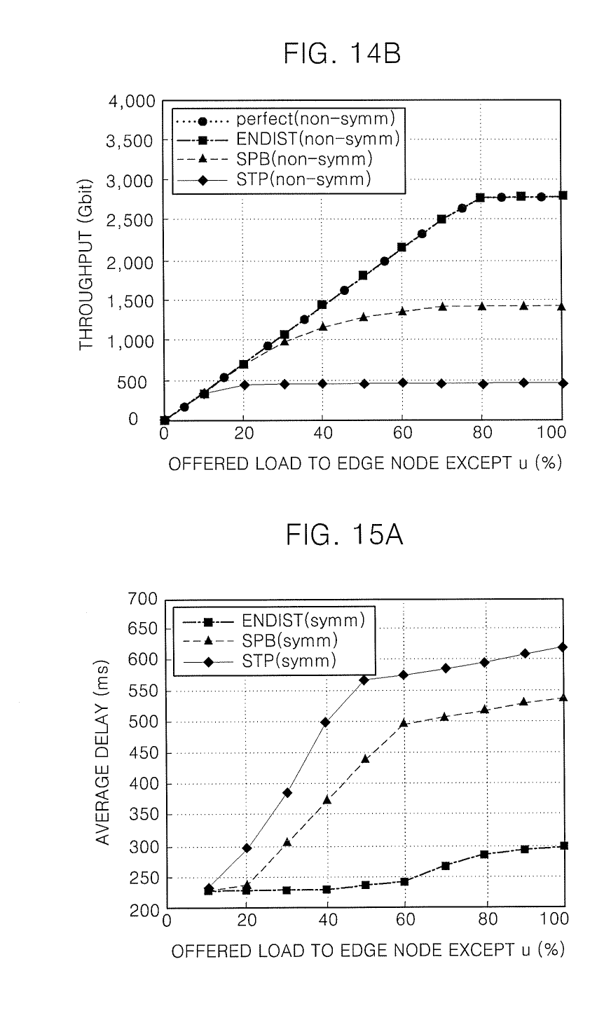

FIGS. 14A and 14B show the throughput with symmetrical and non-symmetrical load distribution, respectively, when the upward traffic rate is 50% in the large backbone network. Referring to FIG. 14B, the perfect routing shows saturated pattern like in the case of the small backbone network, STP has the lowest throughput, and ENDIST has the throughput close to the perfect routing. Especially, in FIG. 14B, ENDIST is identical to the perfect routing. This means ENDIST performs almost perfect.

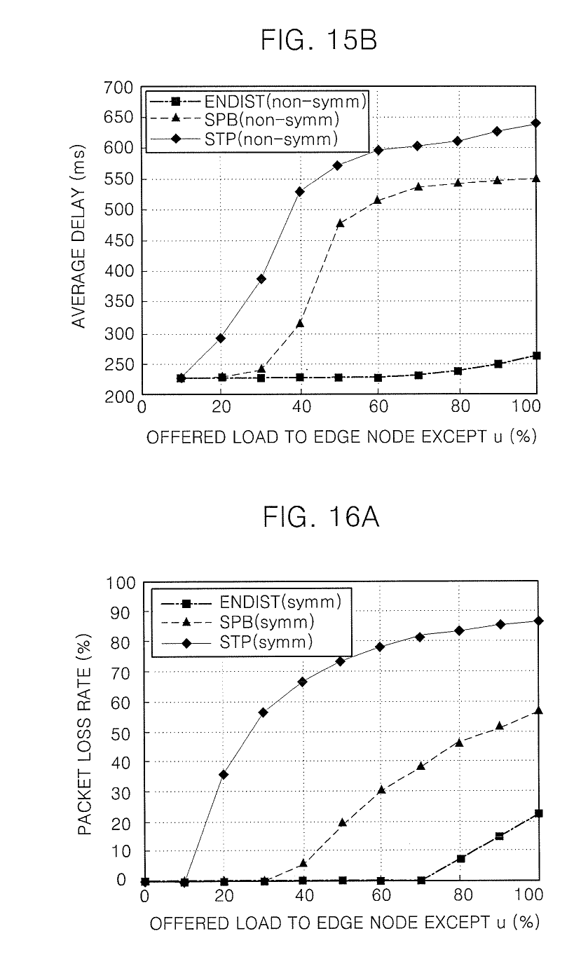

FIGS. 15A and 15B show the average delay in symmetrical and non-symmetrical load distribution, respectively, when the upward traffic rate is 50% in the large backbone network. Referring to FIG. 15B, ENDIST performs the lowest average delay. The average delay of ENDIST hardly increases because queue size is always very small.

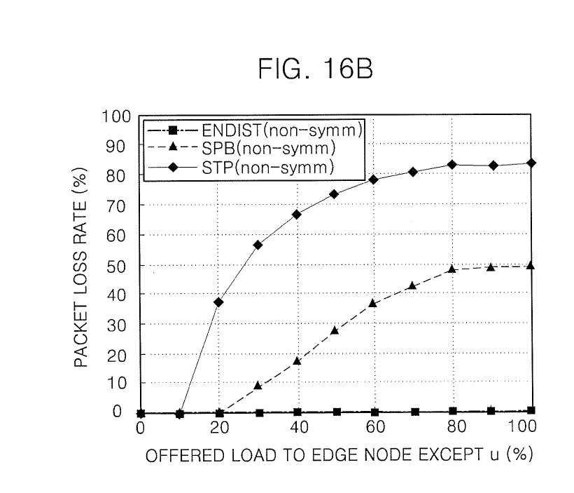

FIGS. 16A and 16B show the packet loss rate in symmetrical and non-symmetrical load distribution, respectively, when the upward traffic rate is 50% in the large backbone network. Referring to FIGS. 16A and 16B, the packet loss occurs in STP after 10% of traffic is generated. In SPB, the packet loss occurs in symmetrical load distribution after 30% of traffic is generated, and in non-symmetrical load distribution after 20% of traffic is generated. ENDIST that performs much like the perfect routing does not lose packets in non-symmetrical load distribution.

Table 4 shows the relative throughput that is standardized on the perfect routing in the large backbone network.

TABLE 4

| | 20% | 20% | 50% | 50% |
|---|---|---|---|---|
| | (symm) | (non-symm) | (symm) | (non-symm) |
| perfect | 1.00 | 1.00 | 1.00 | 1.00 |
| ENDIST | 0.54 | 0.75 | 0.78 | 0.99 |
| SPB | 0.33 | 0.45 | 0.44 | 0.51 |
| STP | 0.16 | 0.21 | 0.13 | 0.17 |

Referring to Table 4, Table 4 shows the throughput with the same format of Table 3. The only difference is that Table 4 uses simulation data from the large backbone network. In each result, the transmission rate of ENDIST is 1.6 times higher than that of SPB.

ENDIST has the following excellent properties from simulation. In the aspect of throughput, ENDIST performs more than three times better than STP, and 1.5 times better than SPB. In the aspect of delay, ENDIST shows comparably small delay than STP and SPB. The queue of ENDIST seldom overflows, and the average delay is remarkably lower than STP or SPB because ENDIST uses all links connected to sub-nodes. In the aspect of packet loss, ENDIST has smaller packet loss than STP or SPB. That is, as general evaluation, ENDIST outperforms STP and SPB regardless of the size of backbone network. Especially, ENDIST is robust to the unbalanced traffic. Thus, it is confirmed that ENDIST has superior performance than STP or SPB.

To sum up, ENDIST increases a transmission rate that defines traffic that can be transmitted in network per unit time in comparison with STP and SPB and enhances transmission quality of traffic. Furthermore, since ENDIST always has a plurality of independent paths, when a portion of a path is disconnected, the path can be immediately changed into other path such that recovery time can be remarkably reduced.

In the node device and the method for deciding a shortest path using a spanning tree according to the present invention, the throughput of traffic is 3 times and 1.5 times larger than in existing STP and SPB, respectively, and the transmission delay is smaller than in existing STP and SPB. In addition, according to the present invention, the packet loss rate is smaller than in existing STP and SPB. In this way, the node device and the method for deciding a shortest path using a spanning tree according to the present invention show better performance than in existing STP and SPB regardless of the size of the backbone network. In particular, the node device and the method for deciding a shortest path using a spanning tree according to the present invention are robust to the unbalanced traffic. In addition, a plurality of paths that reach an automatically-extracted destination node can be used as a backup path immediately when an outage of links or nodes occurs so that re-transmission time can be remarkably reduced.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A node device comprising:
a node division unit dividing the node device into sub-nodes as many as the number of nodes connected to the node device when the node device operates an edge node that is located at an end of a backbone network and is in charge of reformatting and routing frames;
a spanning tree generation unit generating as many spanning trees as the number of sub-nodes, wherein each of the spanning trees comprises a shortest path to reach the other edge nodes constructing the backbone network from each of the sub-nodes; and
a first path decision unit deciding a shortest path from a source node to a predetermined destination node, as a path to be used, based on the spanning trees that are generated by the spanning tree generation unit.

2. The node device of claim 1, further comprising a second path decision unit deciding a final path among a plurality of paths based on a traffic state in the backbone network if there are a plurality of paths decided by the first path decision unit.

3. The node device of claim 2, wherein the second path decision unit decides a final path among a plurality of paths that are decided by the first path decision unit based on the spanning trees, based on transmission delay or an output queue length.

4. The node device of claim 2, wherein the spanning tree generation unit generates temporary spanning trees including a path to reach sub-nodes of the other edge nodes and the other intermediate nodes and prunes links including a long path among links connected to sub-nodes of another edge node of the temporary spanning tree, thereby generating the spanning trees.

5. The node device of claim 2, wherein, if traffic cannot be transmitted on the decided path to be used, the first path decision unit decides a shortest path that is not decided as the path to be used, among shortest paths from the source node to the destination node on each of the spanning trees corresponding to each of the sub-nodes, as an alternate path.

6. The node device of claim 1, wherein the first path decision unit decides the path to be used in flow-basis.

7. The node device of claim 1, wherein the node division unit allocates Media Access Control (MAC) addresses to each of the sub-nodes by using lower two to three bits as a sub-node serial number.

8. The node device of claim 1, wherein the spanning tree generation unit generates temporary spanning trees including a path to reach sub-nodes of the other edge nodes and the other intermediate nodes and prunes links including a long path among links connected to sub-nodes of another edge node of the temporary spanning tree, thereby generating the spanning trees.

9. The node device of one of claims 1, wherein, if traffic cannot be transmitted on the decided path to be used, the first path decision unit decides a shortest path that is not decided as the path to be used, among shortest paths from the source node to the destination node on each of the spanning trees corresponding to each of the sub-nodes, as an alternate path.

10. A method for deciding a shortest path using a spanning tree at an edge not that is located at an edge of a backbone network and is in charge of reformatting and routing frames, the method comprising:
dividing the node device into sub-nodes as many as the number of nodes connected to the node device;
generating as many spanning trees as the number of sub-nodes, wherein each of the spanning trees comprises a shortest path to reach the other edge nodes constructing the backbone network from each of the sub-nodes; and
deciding a shortest path from a source node to a predetermined destination node, as a path to be used, based on the spanning trees.

11. The method of claim 10, further comprising, if there are a plurality of paths decided in the deciding of the shortest path, deciding a final path among a plurality of paths based on a traffic state in the backbone network.

12. The method of claim 11, wherein the deciding of the final path comprises deciding a final path among a plurality of paths that are decided based on the spanning trees, based on transmission delay or an output queue length.

13. The method of claim 11, wherein the generating of the spanning trees comprises:
generates temporary spanning trees including a path to reach sub-nodes of the other edge nodes and the other intermediate nodes; and
generating the spanning trees by pruning links including a long path among links connected to sub-nodes of another edge node of the temporary spanning tree.

14. The method of claim 11, wherein, if traffic cannot be transmitted on the decided path to be used, the deciding of the shortest path comprises deciding a shortest path that is not decided as the path to be used, among shortest paths to the destination node on each of the spanning trees corresponding to each of the sub-nodes, as an alternate path.

15. The method of claim 10, wherein the deciding of the shortest path comprises deciding the path to be used in flow-basis.

16. The method of claim 10, wherein the dividing of the node device into the sub-nodes comprises allocating Media Access Control (MAC) addresses to each of the sub-nodes by using lower two to three bits as a sub-node serial number.

17. The method of claim 10, wherein the generating of the spanning trees comprises:
generates temporary spanning trees including a path to reach sub-nodes of the other edge nodes and the other intermediate nodes; and
generating the spanning trees by pruning links including a long path among links connected to sub-nodes of another edge node of the temporary spanning tree.

18. The method of claim 10, wherein, if traffic cannot be transmitted on the decided path to be used, the deciding of the shortest path comprises deciding a shortest path that is not decided as the path to be used, among shortest paths to the destination node on each of the spanning trees corresponding to each of the sub-nodes, as an alternate path.

19. A computer readable recording medium having recorded thereon a program for executing the method of claim 10.
